(19) United States
(12) Patent Application Publication
(10) Pub. No.: US 2020/0158632 A1
(43) Pub. Date: May 21, 2020

(54) Test System for a Holographic Optical Element

(71) Applicant: LUMINIT LLC, Torrance, CA (US)

(72) Inventors: MATTHEW STEVENSON, LONG BEACH, CA (US); JUAN RUSSO, TORRANCE, CA (US); SETH COE-SULLIVAN, TORRANCE, CA (US)

(21) Appl. No.: 16/689,050

(22) Filed: Nov. 19, 2019

Related U.S. Application Data
(60) Provisional application No. 62/769,074, filed on Nov. 19, 2018.

(51) Int. Cl. G01N 21/47; G01M 11/02; G01N 21/27; G02B 5/32

(52) U.S. Cl. CPC G01N 21/4788; G01M 11/0207; G02B 5/32; G01N 21/27; G01M 11/0242

(57) ABSTRACT

This application discloses a system and method for measuring the optical performance of an HOE or a population of HOEs in a single or mass production environment using light.

### CROSS-REFERENCE TO RELATED APPLICATION

This application claims priority to U.S. Provisional Patent Application Ser. No. 62/769,074 filed Nov. 19, 2018, whose disclosure is incorporated herein by reference.

### TECHNICAL FIELD

This application is directed to a measurement and inspection system for a holographic optical element (HOE), or a population of HOEs, especially in a mass production environment. Specifically, this application relates to a system designed for performance measurements and quality measurements of an HOE.

### BACKGROUND

It is estimated that the combined revenues for sales of augmented reality (AR), virtual reality (VR), and smart glasses will approach $80 billion by the year 2025. About half of that revenue is directly proportional to the hardware of the devices and the optics are key. However, despite this popularity and huge demand, such devices remain difficult to manufacture. One reason is that traditional optical elements are limited to the laws of refraction and reflection, which require cumbersome custom optical elements that are difficult to fabricate to form a usable image in the wearer's visual field. Another reason is that refractive optical materials are heavy in weight. Yet another reason is that reflective optical trains result in bulky and nonergonomic designs. These limitations of traditional optical elements result in devices that are less than satisfactory to the public.

In contrast to conventional optics, the flexibility provided by HOE fabrication facilitates the production of an attractive, conformable, useful, and easy to use consumer electronic product. HOEs are thin and can be custom fabricated for ergonomic input and output angles with relative ease. HOEs such as LUMINIT® Transparent Holographic Components™ are transparent, light, thin, and allow for arbitrary incident and diffraction angles. As HOEs become mass-produced, it would be highly advantageous to have the capability to monitor the both the performance and quality of HOEs quickly, easily, and accurately in a mass production environment.

Currently, the monitoring of the performance and quality of HOEs is cumbersome and time-consuming in the performance of the individual testing, in the analysis of the data, and in the interruption of the manufacturing process. Thus, there exists a need for an effective solution to the problem of the inability to test the performance and quality of HOEs quickly, simply, and precisely, which the present system addresses.

### BRIEF SUMMARY

The present application is directed to an apparatus and method that facilitate the automated, accurate measurement of the optical performance of an HOE or of a population of HOEs. One embodiment of a system for the measurement of optical performance of an HOE includes a laser source, a detector, a rotation stage, and a translation stage.

Yet another embodiment includes a system comprising a broadband light source, a means of spatially collecting diffracted light, a spectrometer, a rotation stage, and one or more translational stages.

Another embodiment includes a method of measuring the optical performance of a HOE that involves measuring a diffraction efficiency, a diffraction angle, an incident angle, and an angular bandwidth of an HOE.

Still another embodiment includes a method of preparing a population of holographic optical elements, which encompasses obtaining an optical power measurement and an angular dependence of emission measurement for each member of the population of holographic optical elements.

The angular test system of this application has several benefits and advantages. As the HOE moves from the lab and into mass production a new suite of testing equipment needed to be developed to be able to produce data useful for qualifying parts for customer use. Often, the primary consideration for customer acceptance is the performance of the parts. The system described here was developed to measure the performance of these parts and provide a way to certify product performance singly or in mass quantities, prior to shipment and sale.

### BRIEF DESCRIPTION OF THE DRAWINGS

FIG. 1 illustrates the beams and angles for HOE analysis of holograms in (a) REFLECTION mode and (b) TRANSMISSION mode.

FIG. 2 is a graph of the angular bandwidth definition for HOE.

FIG. 3 illustrates schematic configurations of two systems that accurately measure the optical power and the angular dependence of emission of the HOE.

FIG. 4 illustrates a block diagram describing the system of HOE measurement.

FIG. 5 is a drawing of the system.

FIG. 6 is one exemplary photograph of the HOE measurement system.

FIG. 7 illustrates one embodiment of the HOE measurement system.

### DETAILED DESCRIPTION OF EXEMPLARY EMBODIMENTS

The present application relates to an apparatus and system for accurately measuring the optical performance of an HOE singly, or in a mass production environment. The system can be advantageously used to accurately monitor the quality of mass quantities of HOEs. The apparatus described here provides meticulous, detailed information on the quality of the HOEs in a rapid timeframe. The system comprises an automated system for analyzing performance of a holographic optical element comprising: (a) one or more laser sources, (b) a detector, (c) a rotation stage, and (d) one or more translation stages. The position of the holographic optical element is monitored and adjusted for by rotational and translational stages.

In an alternative embodiment, the system for measurement of optical performance of a holographic optical element comprises a broadband light source, a means of spatially collect diffracted light, a spectrometer, a rotation stage, and one or more translation stages.

On the performance side, there are several basic metrics that can be used to evaluate the performance of an HOE:

Diffraction efficiency: The efficiency of the HOE in diffracting incident light in the designed direction

Diffraction Angle: The angle at which the majority of the diffracted light is directed Incident Angle: The angle at which light enters the HOE that provides for maximum diffraction efficiency

Angular bandwidth: The width (in terms of angle) of light accepted by the HOE for diffraction

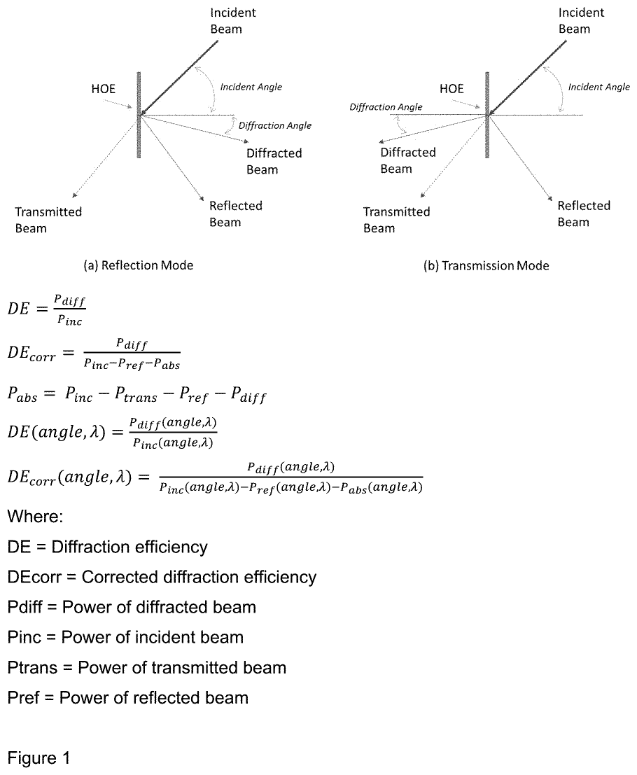

The angles mentioned above can be described by the diagram in FIG. 1, which shows that light incident on the HOE (incident beam) can be directed in several ways upon interacting with the HOE. Some light passes through the HOE (transmitted beam), some is reflected in the classical way (reflected beam), and some is diffracted per the HOE's design (diffracted beam). By measuring the power of the four beams, it is possible to calculate the diffraction efficiency of the HOE per the equations below:

$$\begin{matrix}DE = \frac{{P}_{diff}}{{P}_{inc}} & eqn 1 \\ {DE}_{corr} = \frac{{P}_{diff}}{{P}_{inc} - {P}_{ref} - {P}_{abs}} & eqn 2 \\ Pabs = Pine - Ptrans - Pdiff & eqn 3\end{matrix}$$

DE=Diffraction efficiency
DEcorr=Corrected diffraction efficiency
Pdiff=Power of diffracted beam
Pinc=Power of incident beam
Ptrans=Power of transmitted beam
Pref=Power of reflected beam

The diffraction efficiency of the HOE can be calculated from Equation 1, and is based solely on the ratio of the diffracted power to the power of the incident beam. It is also possible to calculate the corrected diffraction efficiency, per Equations 2 and 3, which corrects the diffraction efficiency for losses due to standard reflection and optical absorption within the HOE.

In addition, the HOE is designed to have a maximum diffraction efficiency at a specified combination incident angle and diffraction angle and it is useful to be able to capture the actual angles at which maximum diffraction efficiency occurs for a fabricated HOE as part of the evaluation of its performance.

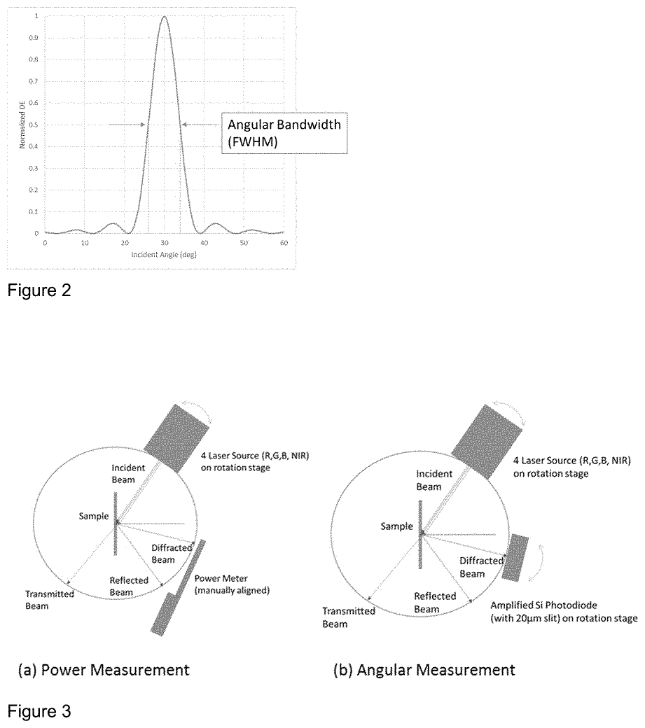

Finally, the HOE incident angle will have some characteristic range about the angle of maximum diffraction where there is still significant diffraction, which is known as the angular bandwidth. An example of this distribution is shown in FIG. 2. As FIG. 2 shows, the angular bandwidth is quantified as the full-width at half maximum (FWHM) of the distribution of normalized diffraction efficiency vs incident angle of the HOE.

In order to capture the quantitative metrics described above, a system was developed that is capable of accurately measuring optical power and the angular dependence of emission. The system is shown schematically in FIG. 3, and exists in two configurations: one for power measurements, and one for accurate angular measurements.

The two configurations share several common components and differ primarily in the measurement equipment. The four laser source is comprised of a series of connected beam-splitters that serve to combine the emission from red, green, blue, and NIR laser diodes mounted with provisions for the individual alignment of the beams to ensure that they are aligned properly when incident on the sample. The four laser source is mounted on an automated rotation stage set up such that the laser source orbits a center of rotation that is lined up precisely on the surface of the sample under test. The sample itself is mounted on a stage that allows for translation in the x-, y-, and z-axes (x and y being defined as perpendicular to the sample normal, and z along the sample normal). The x- and y-axis alignment allows different regions of the HOE to be probed in order to understand the performance of the HOE across the active area. The z-axis alignment ensures that the sample is located properly with respect to the rotational axis of the system, a necessary adjustment in case of changes in sample or substrate thickness during development.

In the case of the power measurement configuration, the power of the various beams is measured using a standard silicon power meter, such as a Thorlabs PM320E with a Thorlabs S130C 1 cm2 measurement head. To perform the power measurement, the power meter is first positioned to measure the diffracted beam (at the focal point of the output in the case of a lensing HOE system). Then the incident angle is rotated and the diffracted beam power is measured remotely via a LabView program. The resulting data shows the diffracted beam power vs. incident beam angle, and can be used to determine the optimum incident beam angle of the HOE for use in subsequent measurements. Once the optimum incident beam angle has been determined, the laser incident angle is set to the optimum value and the other power quantities are measured by aligning the power meter with the beam in question.

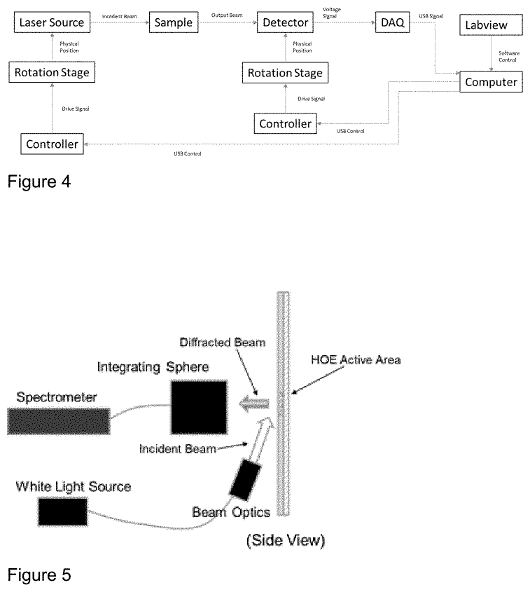

To determine the angular quantities, the power meter is replaced with an amplified silicon photodiode such as a Thorlabs PDA 100A with a 20 um slit mounted to the detector region to limit the angular acceptance of the detector and allow for accurate angular measurements. The detector is mounted on an automated rotational stage in a way similar to that used to mount the four laser source, and resulting in a detector that orbits the sample in the same way. To determine the diffracted, transmitted, and reflected angles, the incident angle is set to the optimum value determined in the previous power measurements, and the detector is swept around the sample using the rotational stage. As before, a Labview program both controls the stage and reads the detector signal, resulting in data that shows accurately the angle of the diffracted, reflected and transmitted beams. To determine the angular bandwidth of the HOE, the detector is set to the angle of the diffracted beam determined previously, and the four laser source is swept through a range of incident angles to create a data set similar to that shown graphically in FIG. 2, which allows the calculation of the angular bandwidth. FIG. 3 shows a schematic of power measurement and angular measurement of the HOE. A block diagram describing the entire measurement set-up appears in FIG. 4. The holographic optical element can be positioned on a web that is moving past each component of the system wherein each component takes multiple analyses of the holographic optical element. A marking mechanism for the HOE can also be utilized in the system. The spectrometer can have a spectral range in the ultraviolet, visible, or near infrared and spectral accuracy of less than or equal to 0.5 nm or less. A narrow band filter can be used to reduce light incident on the HOE to a bandwidth of about 2-3 nm. The system can be mounted on a base.

Some considerations for the individual components of the system are:

Lasers: The lasers need to be chosen with respect to the operating wavelengths for the product being tested. They should have a small spot size (−1 mm diameter), provide sufficient power to enable strong measurement signals, and be stable for long term operation. It may be necessary to use optics to collimate the laser beam. A Thorlabs CPS450 laser diode module would be a good choice. Other laser diodes and modules would work also.

Rotation Stage: Rotation stages are optical system components, and can be manual or automated. An example of a suitable manual stage would be a Thorlabs CR1 stage. Using a motorized rotation stage is advantageous in terms of repeatability and ergonomics. An example of a motorized stage would be a Thorlabs PRMTZ8.

Translation Stage: The same considerations apply to the translation stage as to the rotation stage. An example of a manual translation stage would be a Thorlabs PT1B, while an example of a motorized translation stage would be a Thorlabs PT1-Z8.

General Construction: The apparatus is constructed from a optomechanical components (posts, optics mounts, etc.) from Thorlabs.

Using the method and system described above, a population of holographic optical elements can be prepared by: obtaining power measurements and angular dependence; and grouping member holograms of similar power and angular performance. Operation of the system is triggered by machine-vision reading of a fiducial mark on the holographic optical element to begin analysis of the holographic optical element. As shown by the system above one or more narrow-band (laser) wavelengths were selected for testing. Hence, the metrics described herein can be obtained for one or multiple wavelengths of light.

The system above was expanded to include broadband ranges of wavelengths by replacing the lasers with a broadband white light source. In this case, the metrics are simultaneously measured for a broad spectrum of light (replacing the detector with an integrating sphere as means to collect spatially dispersed light and a spectrometer) and range of angles (by means of the rotation stage). In this case the diffraction efficiency metrics can be defined in 2 distinct dimensions: angle and wavelength as shown in equation 4 below.

$$\begin{matrix}DE ( angle , λ ) = \frac{{P}_{diff} ( angle , λ )}{{P}_{inc} ( angle , λ )} & eqn 4 \\ {DE}_{corr} ( angle , λ ) = \frac{{P}_{diff} ( angle , λ )}{{P}_{inc} ( angle , λ ) - {P}_{ref} ( angle , λ ) - {P}_{abs} ( angle , λ )} & eqn 5\end{matrix}$$

A system is shown in FIG. 5, which is for white light measurement of the HOE. The steps performed at this station are listed below: adjust translation stage to align measurement system with part; project a 3 mm-diameter beam of white light (incident beam) onto the center of the HOE under test; measure the spectrum of the diffracted beam and extract performance parameters.

The system projects a small beam of white light onto the sample and uses an integrating sphere to capture light diffracted by the HOE. Spectral analysis of this light provides performance information for each part such as diffraction efficiency, bandwidth, and peak diffraction wavelength for each color. After the above is performed for an angular position of the integrating sphere, the rotation stage allows to scan other angular positions.

The hardware considerations of this station are as follows:

Spectrometer—The spectrometer used here should have a spectral range sufficient to account for the output wavelengths of interest to the hologram and a spectral accuracy of 0.5 mm or less. The current system uses a Thorlabs CCS100.

Integrating Sphere—The integrating sphere should be small enough to allow sensitivity to signal of the magnitude expected from the HOEs being tested, but large enough to properly eliminate any angular dependence in the data collection. Currently, a Thorlabs IS236A in used in the system.

White Light Source—The light source used here should provide broadband spectral output over the wavelength range of interest. Currently a Thorlabs MWWHF2 fiber-coupled LED is used in the system.

Beam Optics—The beam optics are used to control the size of the incident beam and to collimate it. To this end, a combination of irises, lenses, and mounting hardware that could be used to make the 3 mm or less diameter beam required by the current system.

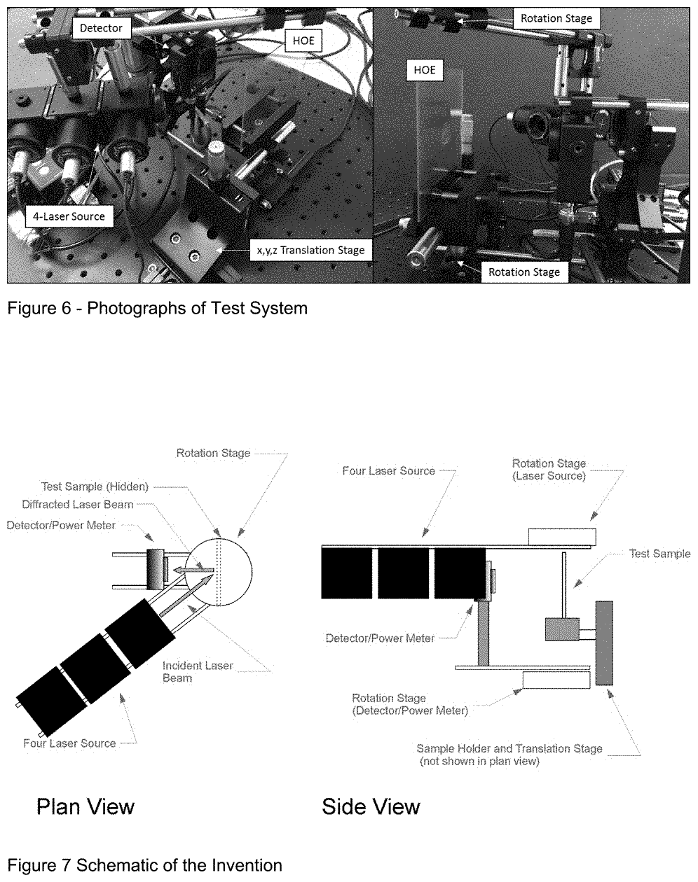

Fiber Optics—The light source and the spectrometer are connected to the system via fiberoptic cables. As high light throughput and physical robustness are required in this application, it employs a Thorlabs FT1500umT cable with a fiber diameter of 1500 um and a stainless-steel jacket to connect both of these elements to the system. FIG. 6 is one exemplary photograph of the HOE measurement system. FIG. 7 illustrates one embodiment of the HOE measurement system.

Using the method and system described above, a population of holographic optical elements can be prepared by obtaining power measurements and angular and spectral dependence, then grouping member holograms of similar power, angular performance and spectral performance. A computer can be used for storage and analysis of data.

The metrics and testing parameters described herein make it possible to fabricate a transparent manufacture comprising one or more populations of member holograms wherein each population has a distinct statistical characteristic angular dependence, spectral dependence, diffraction efficiency and uniformity. This transparent manufacture can be a roll with a population of member holograms, or singulated or otherwise individual member holograms grouped into a population.

In this area, narrow angular and spectral performance is often referred to as transparency. In other words, transparency is important as the wearer has an unobstructed view of the environment (AR) or of another display (VR) while the optical system overlays specific images and information. Volume HOEs operating in the thick regime are especially suited to provide the required transparency while overlaying the images with high efficiency. Although surface relief diffractive optical elements are easy to manufacture by embossed replication, they add scattering and multiple diffraction orders, causing ghosting, reducing efficiency, and compromising see-through operation. Conversely, thick volumetric HOEs can be designed to diffract in only one order with minimal scattering, eliminating ghosting, and maximizing efficiency and see-through transparent performance. Like surface relief structures, volume HOEs can be manufactured in a master and replication schemes.

Alternative embodiments of the subject matter of this application will become apparent to one of ordinary skill in the art to which the present invention pertains without departing from its spirit and scope. It is to be understood that no limitation with respect to specific embodiments shown here is intended or inferred.

We claim:

1. An automated system for analyzing performance of a holographic optical element comprising: (a) one or more laser sources, (b) a detector, (c) a rotation stage, and (d) one or more translation stages.

2. The system of claim 1 wherein a position of the holographic optical element is monitored and adjusted for by rotational and translational stages.

3. The system of claim 1 wherein operation of the system is triggered by machine-vision reading of a fiducial mark on the holographic optical element to begin analysis of the holographic optical element.

4. The system of claim 1 further comprising a computer for storage and analysis of data.

5. The system of claim 1 wherein means of spatially measuring diffracted light comprises a power meter or a photodiode.

6. A system for measurement of optical performance of a holographic optical element comprising a broadband light source, a means of spatially collecting diffracted light, a spectrometer, a rotation stage, and one or more translation stages.

7. The system of claim 6 wherein the broadband light source comprises an LED light.

8. The system of claim 6 further comprising an integrating sphere to capture spatially dispersed light and light diffracted by the holographic optical element.

9. The system of claim 1 wherein the holographic optical element is positioned on a web that is moving past each component of the system wherein each component takes multiple analyses of the holographic optical element.

10. The system of claim 1 further comprising a marking mechanism for the holographic optical element.

11. The system of claim 1 wherein the spectrometer comprises a spectral range in the ultraviolet, visible or near infrared and spectral accuracy of less than or equal to 0.5 nm or less.

12. The system of claim 8 wherein the integrating sphere has a size small enough to register sensitivity of the holographic optical element but large enough to eliminate angular dependence in data collection.

13. The system of claim 1 wherein the light comprises a beam of about 3 mm or less.

14. The system of claim 1 further comprising fiber optics to connect the light source and the spectrometer.

15. The system of claim 1 further comprising a narrow band filter that reduces light incident on the holographic optical element to a bandwidth of about 2-3 nm.

16. The system of claim 1 that is mounted on base.

17. The system of claim 1 wherein the holographic optical element comprises a collection of holographic optical elements with matching performance characteristics.

18. A method of measuring optical performance of a holographic optical element comprising one or more steps of: measuring a diffraction efficiency, a diffraction angle, an incident angle, and an angular bandwidth of a holographic optical element.

19. The method of claim 18 wherein the holographic optical element comprises a collection of holographic optical elements with matching performance characteristics.

20. A method of preparing a population of holographic optical elements comprising obtaining an optical power measurement and an angular dependence of emission measurement for each member of a population of holographic optical elements.
